(19) United States
(12) Patent Application Publication
(10) Pub. No.: US 2010/0024378 A1
(43) Pub. Date: Feb. 4, 2010

(54) SYSTEM AND METHOD OF OPERATING A GAS TURBINE ENGINE WITH AN ALTERNATIVE WORKING FLUID

(76) Inventors: John Frederick Ackermann, Laramie, WY (US); Matthew Timothy Franer, Norwood, OH (US); Randy Lee Lewis, Lebanon, OH (US); David Allen Bell, Laramie, WY (US); Morris Dee Argyle, Laramie, WY (US); Brian Francis Towler, Laramie, WY (US)

Correspondence Address: JOHN S. BEULICK (12729);C/O ARMSTRONG TEASDALE LLP, ONE METROPOLITAN SQUARE, SUITE 2600, ST. LOUIS, MO, 63102-2740, US

(21) Appl. No.: 12/182,898

(22) Filed: Jul. 30, 2008

(51) Int. Cl. F02C 7/141

(52) U.S. Cl. 60/39.5; 60/772

(57) ABSTRACT

A gas turbine engine system is provided. The gas turbine engine system includes a gas turbine engine and an exhaust gas conditioning system. The gas turbine engine includes at least one combustion chamber and at least one turbine downstream from the combustion chamber. The combustion chamber is coupled in flow communication to a source of hydrocarbonaceous fuel and to a source of oxygen. The gas turbine engine is operable with a working fluid that is substantially nitrogen-free. The exhaust gas conditioning system is coupled between a discharge outlet of the gas turbine engine and an inlet of the gas turbine engine.

### BACKGROUND OF THE INVENTION

The present disclosure relates generally to gas turbine engines and, more particularly, to gas turbine engine systems that operate with an alternative working fluid.

Gas turbine engines produce mechanical energy using a working fluid supplied to the engines. More specifically, in known gas turbine engines, the working fluid is air that is compressed and delivered, along with fuel and oxygen, to a combustor, wherein the fuel-air mixture is ignited. As the fuel-air mixture burns, its energy is released into the working fluid as heat. The temperature rise causes a corresponding increase in the pressure of the working fluid, and following combustion, the working fluid expands as it is discharged from the combustor downstream towards at least one turbine. As the working fluid flows past each turbine, the turbine is rotated and converts the heat energy to mechanical energy in the form of thrust or shaft power.

Air pollution concerns worldwide have led to stricter emissions standards both domestically and internationally. Pollutant emissions from at least some gas turbines are subject to Environmental Protection Agency (EPA) standards that regulate the emission of oxides of nitrogen (NOx), unburned hydrocarbons (HC), and carbon monoxide (CO). In general, engine emissions fall into two classes: those formed because of high flame temperatures (NOx), and those formed because of low flame temperatures that do not allow the fuel-air reaction to proceed to completion (HC & CO).

Air has been used as a working fluid because it is readily available, free, and has predictable compressibility, heat capacity, and reactivity (oxygen content) properties. However, because of the high percentage of nitrogen in air, during the combustion process, nitrogen oxide (NOx) may be formed. In addition, carbon contained in the fuel may combine with oxygen contained in the air to form carbon monoxide (CO) and/or carbon dioxide (CO₂).

To facilitate reducing NOx emissions, at least some known gas turbine engines operate with reduced combustion temperatures and/or Selective Catalytic Reduction (SCR) equipment. However, operating at reduced combustion temperatures reduces the overall efficiency of the gas turbine engine. Moreover, any benefits gained through using known SCR equipment may be outweighed by the cost of the equipment and/or the cost of disposing the NOx. Similarly, to facilitate reducing CO and/or CO₂ emissions, at least some known gas turbine engines channel turbine exhaust through a gas separation unit to separate CO₂ from N₂, the major component when using air as the working fluid, and at least one sequestration compressor. Again however, the benefits gained through the use of such equipment may be outweighed by the costs of the equipment.

### BRIEF DESCRIPTION OF THE INVENTION

In one aspect a method of operating a turbine engine system is provided. The method comprises supplying a flow of oxygen to a combustion chamber defined within the turbine engine system, supplying a flow of hydrocarbonaceous fuel to the combustion chamber, and supplying a working fluid to an inlet of the turbine engine system, wherein the working fluid is substantially nitrogen-free and wherein turbine engine system is operable with the resulting fuel-oxygen-working fluid mixture.

In another aspect, a gas turbine engine system is provided. The gas turbine engine system includes a gas turbine engine and an exhaust gas conditioning system. The gas turbine engine includes at least one combustion chamber and at least one turbine downstream from the combustion chamber. The combustion chamber is coupled in flow communication to a source of hydrocarbonaceous fuel and to a source of oxygen. The gas turbine engine is operable with a working fluid that is substantially nitrogen-free. The exhaust gas conditioning system is coupled between a discharge outlet of the gas turbine engine and an inlet of the gas turbine engine.

In a further aspect an engine is provided. The engine includes an inlet, a combustion chamber, and an engine outlet. The combustion chamber is coupled in flow communication between the engine inlet and the engine outlet. The combustion chamber is coupled to a source of hydrocarbonaceous fuel, and to a source of oxygen. The inlet is coupled in flow communication to the outlet for receiving a source of substantially nitrogen-free working fluid discharged from the outlet.

### BRIEF DESCRIPTION OF THE DRAWINGS

FIG. 1 is a schematic illustration of an exemplary gas turbine engine.

FIG. 2 is a schematic illustration of an exemplary turbine engine system that may include the gas turbine engine shown in FIG. 1.

### DETAILED DESCRIPTION OF THE INVENTION

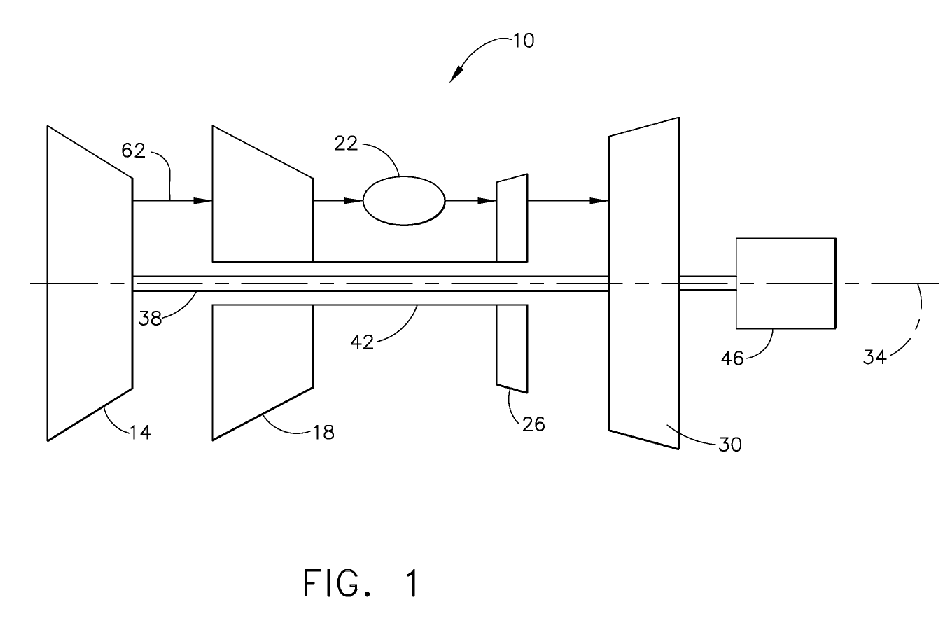

FIG. 1 is a schematic illustration of an exemplary gas turbine engine 10. In the exemplary embodiment, engine 10 includes a low pressure compressor 14, a high pressure compressor 18 downstream from low pressure compressor 14, a combustor assembly 22 downstream from high pressure compressor 18, a high pressure turbine 26 downstream from combustor assembly 22, and a low pressure turbine 30 downstream from high pressure turbine 26. Moreover, in the exemplary embodiment, compressors 14 and 18, combustor assembly 22, and turbines 26 and 30 are coupled together in a serial flow communication

In the exemplary embodiment, the rotatable components of gas turbine engine 10 rotate about a longitudinal axis indicated as 34. A typical configuration for engines of this type is a dual concentric shafting arrangement, wherein low pressure turbine 30 is drivingly coupled to low pressure compressor 14 by a first shaft 38, and high pressure turbine 26 is drivingly coupled to high pressure compressor 18 by a second shaft 42 that is internal to, and concentrically aligned with respect to, shaft 38. In the exemplary embodiment, low pressure turbine 30 is coupled directly to low pressure compressor 14 and to a load 46. For example, in one embodiment, engine 10 is manufactured by General Electric Company of Evendale, Ohio under the designation LM6000. Although the present invention is described as being utilized with gas turbine engine 10, it will be understood that it can also be utilized with marine and industrial gas turbine engines of other configurations, such as one including a separate power turbine downstream from low pressure turbine 30 that is connected to a load (e.g., an LM1600 manufactured by General Electric Company), or to a single compressor-turbine arrangement (e.g., the LM2500 manufactured by General Electric Company), as well as with aeronautical gas turbine engines and/or heavy duty gas turbine engines that have been modified appropriately.

During operation, air enters through an inlet and is channeled towards high pressure compressor 14 and then to low pressure compressor 18. Compressed air is delivered to combustor 22 wherein the air is at least mixed with fuel and ignited. Airflow discharged from combustor 18 drives high pressure turbine 26 and low pressure turbine 30 prior to exiting gas turbine engine 10.

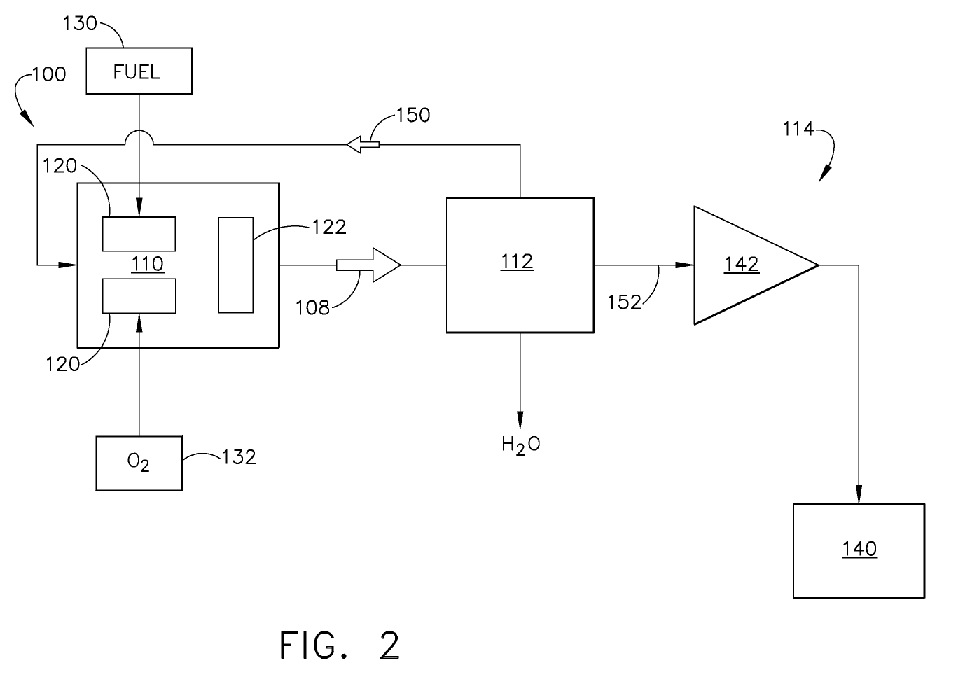

FIG. 2 is a schematic illustration of an exemplary turbine engine system 100 that may be used with gas turbine engine 10 (shown in FIG. 1). Alternatively, system 100 may be used with a land-based and/or aero-derived turbine, a single-or duel-fueled turbine, and/or any turbine that has been modified to enable system 100 to function as described herein. Moreover, system 100 may be used as a simple cycle machine, or may be used within a combined cycle system, including an integrated gasification combined cycle (IGCC) system.

In the exemplary embodiment, system 100 includes a turbine engine 110, a heat exchanger or an air separator unit (ASU) 112, and a sequestration sub-system 114. More specifically, in the exemplary embodiment, turbine engine 110 includes a combustion chamber 120 that is coupled upstream from at least one turbine 122. In other embodiments, engine 110 may include other components, such as, but not limited to, a fan assembly (not shown), and/or at least one compressor, such as compressor 14 (shown in FIG. 1). Moreover, in other embodiments, system 100 may include any exhaust gas conditioner, other than a heat exchanger or ASU, that enables system 100 to function as described herein.

Engine 110 is coupled in flow communication with to a source of hydrocarbonaceous fuel 130 and to a source of oxygen 132. In the exemplary embodiment, fuel supplied from fuel source 130 may be, but is not limited to being, natural gas, syngas and/or distillates. In one embodiment, oxygen is supplied to engine 110 from a pressure-cycle, and/or other O₂ separator. In another embodiment, oxygen source 132 is a pressurized oxygen tank. Moreover, in another embodiment, the source of oxygen 132 is coupled to a pressurizing source (not shown), such as a compressor, to ensure that the supply of oxygen is supplied to engine 110 at a pre-determined operating pressure.

Heat exchanger or an air separator unit (ASU) 112 is coupled downstream from, and in flow communication with, turbine 110, such that exhaust gases 108 discharged from turbine 110 are channeled through exchanger 112. In the exemplary embodiment, heat exchanger 112 facilitates removing heat and water vapor from exhaust gases 108 channeled therethrough. More specifically, in the exemplary embodiment, exchanger 112 is coupled in flow communication with a source of cooling fluid, such as, but not limited to air or water.

Heat exchanger 112 is also coupled upstream from, and in flow communication with, turbine 110, such that heat exchanger 112 supplies working fluid to turbine 110 during engine operations. More specifically, as described in more detail below, in the exemplary embodiment, heat exchanger 112 discharges a stream of CO₂ and steam i.e., a working fluid stream 150, from turbine exhaust 108 to turbine engine 110 for use in combustion chamber 120.

Sequestration sub-system 114 is coupled in flow communication with, and downstream from, heat exchanger 112. As such, during turbine operation, as described in more detail below, a portion of CO₂ and steam, i.e., a sequestration stream 152, from turbine exhaust 108 within heat exchanger 112 is channeled through sequestration sub-system 114. In the exemplary embodiment, heat exchanger 112 effectively removes the steam as condensed water from the turbine exhaust 108 and from sequestration stream 152. Moreover, in the exemplary embodiment, sub-system 114 includes a storage chamber 140 and a compressor 142 that pressurizes the fluid flow transferred from heat exchanger 112 to storage chamber 140. In an alternative embodiment, compressor 142 is coupled in flow communication to a second turbine system (not shown) that uses sequestration stream 152 as a working fluid. Moreover, in another alternative embodiment, sub-system 114 does not include compressor 142, but rather includes any other known component that pressurizes fluid flow channeled to chamber 140, as described herein. In one embodiment, storage chamber 140 is a sub-surface sequestration chamber.

During operation, turbine engine 110 is operated using working fluid 150 that is substantially nitrogen-free. For example, in the exemplary embodiment, the working fluid 150 is between approximately 99 to 100% free from nitrogen. More specifically, and as described in more detail below, in the exemplary embodiment, working fluid stream 150 is substantially carbon dioxide CO₂. For example, in the exemplary embodiment, the working fluid 150 is between approximately 98 and 100% CO₂.

To facilitate start up operations of turbine engine 110, in one embodiment, turbine engine 110 is also coupled to a source of pressurized CO₂. During operations, in the exemplary embodiment, CO₂ is supplied to an inlet (not shown) of combustion chamber 120. In other embodiments, CO₂ may be supplied to an inlet (not shown) of turbine engine 110, and may enter turbine engine 110 upstream from combustion chamber 120, such as, but not limited to, upstream from a fan assembly (not shown). Moreover, engine 110 is also supplied with a flow of hydrocarbonaceous fuel from fuel source 130 and oxygen from oxygen source 132. In the exemplary embodiment, fuel source 130 and oxygen source 132 are each coupled to combustion chamber 120 and supply respective streams of fuel and oxygen directly to combustion chamber 120. The fuel and oxygen are mixed with CO₂ stream 150 and the resulting mixture is ignited within combustion chamber 120. The resulting combustion gases produced are channeled downstream towards, and induce rotation of, turbine 122. Rotation of turbine 122 supplies power to load 46. Exhaust gases 108 discharged from turbine engine 110 are channeled towards heat exchanger 112.

Cooling fluid flowing through heat exchanger 112 facilitates reducing an operating temperature of gases 108, such that water vapor contained in exhaust gases 108 is condensed and such that carbon dioxide CO₂ contained in exhaust gases 108 is substantially separated from the water vapor. Depending on loading requirements of turbine engine 110, the carbon dioxide CO₂ separated from exhaust gases 108 is either returned to engine 110 via working fluid stream 150, or is channeled for sequestration within storage chamber 140 via sequestration stream 152.

Because turbine engine 110 uses working fluid stream 150, and because stream 150 is substantially nitrogen-free, during engine operations, substantially little or no NOx is produced. As such, combustion chamber 120 can be operated at a higher temperature than known combustion chambers operating with air as a working fluid, while maintaining NOx emissions within pre-determined limits. The higher operating temperatures facilitate combustion chamber 120 operating closer to, or at, its thermodynamic optimum. Moreover, the use of a nitrogen-free working fluid 150, facilitates less costly production of power from turbine engine system 100 as compared to known turbine engine systems which use more expensive/less reliable nitrogen/carbon dioxide sequestration equipment.

In addition, because stream 150 is substantially nitrogen-free and only contains substantially carbon dioxide, during engine operations, turbine engine 110 is operable with a higher heat capacity. In some embodiments, the higher heat capacity facilitates the operation of turbine engine system 100 with higher compressor exit pressures at equivalent temperatures (i.e., more compressor stages at equal temperature) as compared to conventional turbine engine systems. As such, the overall operating efficiency of turbine engine system 100 is higher as compared to other known turbine engine systems. Moreover, with the use of working fluid 150, combustion rates within turbine engine system 100 are more easily controlled via control of the amount of oxygen supplied to turbine 110 as compared to the amount of carbon dioxide supplied to turbine 110, i.e., an O₂/CO₂ ratio, as compared to known turbine engine systems. As such, a more uniform heat release and/or advanced re-heat combustion is facilitated to be achieved.

The above-described method and system for operating a turbine engine system with a substantially nitrogen-free working fluid facilitate the production of power from a turbine engine in a cost-efficient and reliable manner. Further, the above-described method and system facilitates reducing the generation of nitrous oxide and carbon dioxide as compared to known turbine engines. As a result, a turbine engine system is provided that facilitates the generation of clean and relatively inexpensive power, while reducing the emission/generation of NOx, CO, and CO₂.

Exemplary embodiments of a method and system for operating a turbine engine with a substantially nitrogen-free working fluid are described above in detail. The method and systems are not limited to the specific embodiments described herein, but rather, steps of the method and/or components of the system may be utilized independently and separately from other steps and/or components described herein. Further, the described method steps and/or system components can also be defined in, or used in combination with, other methods and/or systems, and are not limited to practice with only the method and system as described herein.

When introducing elements of the present invention or preferred embodiments thereof, the articles “a”, “an”, “the”, and “said” are intended to mean that there are one or more of the elements. The terms “comprising”, “including”, and “having” are intended to be inclusive and mean that there may be additional elements other than the listed elements.

As various changes could be made in the above constructions and methods without departing from the scope of the invention, it is intended that all matter contained in the above description and shown in the accompanying drawings shall be interpreted as illustrative and not in a limiting sense.

What is claimed is:

1. A method of operating a turbine engine system, said method comprising:
supplying a flow of oxygen to a combustion chamber defined within the turbine engine system;
supplying a flow of hydrocarbonaceous fuel to the combustion chamber; and
supplying a working fluid to an inlet of the turbine engine system, wherein the working fluid is substantially nitrogen-free and wherein turbine engine system is operable with the resulting fuel-oxygen-working fluid mixture.

2. A method in accordance with claim 1 further comprising:
igniting the fuel-oxygen-working fluid mixture in the combustion chamber; and
channeling a portion of exhaust from the combustion chamber to the inlet of the turbine engine system for use as the working fluid.

3. A method in accordance with claim 2 further comprising channeling exhaust from the combustion chamber to an exhaust gas conditioning system coupled between a discharge outlet of the gas turbine engine and the inlet of the turbine engine system.

4. A method in accordance with claim 3 further comprising channeling a portion of exhaust from the exhaust gas conditioning system to a sequestration storage system.

5. A method in accordance with claim 3 wherein channeling exhaust from the combustion chamber to an exhaust gas conditioning system further comprises channeling exhaust from the combustion chamber to at least one of a heat exchanger and an air separation unit.

6. A gas turbine engine system comprising:
a gas turbine engine comprising at least one combustion chamber and at least one turbine downstream from said combustion chamber, said combustion chamber coupled in flow communication to a source of hydrocarbonaceous fuel and to a source of oxygen, said gas turbine engine operable with a working fluid that is substantially nitrogen-free; and
an exhaust gas conditioning system coupled between a discharge outlet of said gas turbine engine and an inlet of said gas turbine engine.

7. A gas turbine engine system in accordance with claim 6 further comprising a sequestration chamber coupled downstream from said exhaust gas conditioning system for storing at least a portion of exhaust discharged from said gas turbine engine.

8. A gas turbine engine system in accordance with claim 7 wherein said sequestration chamber comprises a sub-surface storage chamber.

9. A gas turbine engine system in accordance with claim 7 wherein said exhaust gas conditioning system comprises at least one of a heat exchanger and an air separation unit coupled in flow communication between said gas turbine engine and said sequestration chamber, and between said gas turbine inlet and discharge outlet.

10. A gas turbine engine system in accordance with claim 9 wherein said exhaust gas conditioning system is configured to facilitate removing at least one of heat and water vapor from exhaust discharged from said gas turbine engine.

11. A gas turbine engine system in accordance with claim 9 wherein said exhaust gas conditioning system is configured to supply a stream of carbon dioxide to said gas turbine engine for use as a working fluid.

12. A gas turbine engine system in accordance with claim 6 wherein said exhaust gas conditioning system facilitates improving an operating efficiency of said gas turbine engine.

13. A gas turbine engine system in accordance with claim 6 wherein said exhaust gas conditioning system facilitates reducing nitrous oxide emissions generated from said gas turbine engine.

14. An engine comprising:
an engine inlet;
a combustion chamber; and
an engine outlet, said combustion chamber coupled in flow communication between said engine inlet and said engine outlet, said combustion chamber coupled to a source of hydrocarbonaceous fuel, to a source of oxygen, said inlet coupled in flow communication to said outlet for receiving a source of substantially nitrogen-free working fluid discharged from said outlet.

15. An engine in accordance with claim 14 further comprising an exhaust conditioning system coupled between a discharge outlet of said gas turbine engine and an inlet of said gas turbine engine.

16. An engine in accordance with claim 15 wherein said exhaust conditioning system comprises at least one of a heat exchanger and an air separation unit.

17. An engine in accordance with claim 15 wherein said exhaust conditioning system is configured to remove at least one of water vapor and heat from the working fluid discharged from said outlet.

18. An engine in accordance with claim 15 further comprising a sequestration system coupled downstream from and in flow communication with said exhaust conditioning system for receiving a portion of flow discharged from said outlet.

19. An engine in accordance with claim 18 wherein said sequestration system further comprises a compressor and a storage chamber, said compressor configured to pressurize flow discharged from said outlet and channeled to said storage chamber.

20. An engine in accordance with claim 15 wherein said exhaust conditioning system facilitates reducing nitrous oxide emissions generated from said engine, said engine.
